(19) United States
(12) Patent Application Publication
(10) Pub. No.: US 2011/0107880 A1
(43) Pub. Date: May 12, 2011

(54) Pliers Having Generally Parallel Jaws

(76) Inventor: Andrew C. Stucky, Winchester, VA (US)

(21) Appl. No.: 12/616,277

(22) Filed: Nov. 11, 2009

(51) Int. Cl. B25B 7/12; B25B 7/14

(52) U.S. Cl. 81/370; 81/389

(57) ABSTRACT

Pliers with parallel jaws include an upper portion having an upper jaw of upper teeth, a lower jaw portion having a lower jaw of lower teeth. The lower jaw portion includes first and second pivot points. An adjustment portion is non-pivotably coupled to the upper portion and selectively movable relative thereto and includes a first pivot point. A lower handle includes first and second pivot points. A break over link includes first and second pivot points pivotably coupled to the adjustment portion and lower handle's first pivot points, respectively. A two-point link includes first and second pivot points pivotably coupled to the upper portion's and lower jaw portion's first pivot points, respectively. A three-point link includes first and second pivot points pivotably coupled to upper and lower jaw portions' first and second pivot points, respectively, and a third pivot point pivotably coupled to the lower handle's second pivot point.

### BACKGROUND OF THE INVENTION

This invention relates generally to hand tools and, more particularly, to pliers having generally parallel jaws.

Conventional locking pliers offer adequate utility for many applications. However, there are instances where the jaws of a traditional pair of pliers do not maintain adequate contact with a work piece to enable a desired manipulation or turning of the piece. For example, attempting to grip the rounded sides of a pin from its end is not accomplished effectively with traditional pliers in that the angled jaws of the pliers would have only one point of contact with the rounded sides and the work piece may pivot in the faulty grip. In another example, a user may desire to apply equal pressure along the entire length of the jaws. Traditional locking pliers are ineffective for this application in that they apply more grip adjacent the pivot point and less pressure near the jaw tips.

Although effective for many applications, traditional pliers do not apply constant pressure along the entire length of both jaws. Therefore, it would be desirable to have pliers with parallel jaws that essentially pinch a work piece evenly along both sides. Further, it would be desirable to have pliers with parallel jaws that are adjustable to grip work pieces of different sizes. In addition, it would be desirable to have pliers with parallel jaws that otherwise operate in the same manner as traditional locking pliers.

### SUMMARY OF THE INVENTION

Therefore, pliers according to the present invention include an upper portion having an upper jaw of planar upper teeth, a lower jaw portion having a lower jaw of planar lower teeth. The lower jaw portion includes first and second pivot points. An adjustment portion is non-pivotably coupled to the upper portion and selectively movable relative to the upper portion and includes a first pivot point. A lower handle includes first and second pivot points. A break over link includes a first pivot point pivotably coupled to the adjustment portion's first pivot point and a second pivot point pivotably coupled to the lower handle's first pivot point. A two-point link includes a first pivot point pivotably coupled to the upper portion's first pivot point and a second pivot point pivotably coupled to the lower jaw portion's first pivot point. A three-point link includes first and second pivot points pivotably coupled to upper and lower jaw portions' first and second pivot points, respectively, and a third pivot point pivotably coupled to the lower handle's second pivot point for moving the generally planar lower teeth between a first position relatively near to the generally planar upper teeth when the lower handle portion rear end is relatively near to the upper portion rear end and a second position relatively distant to the generally planar upper teeth when the lower handle portion rear end is relatively distant to the upper portion rear end.

Therefore, a general object of this invention is to provide pliers with generally parallel jaws that apply pressure evenly to opposite sides of a work piece.

Another object of this invention is to provide pliers with parallel jaws, as aforesaid, that maintain a tight grip on work pieces having irregular shapes that may otherwise move when gripped by traditional pliers.

Still another object of this invention is to provide pliers with parallel jaws, as aforesaid, that are adjustable to grip work pieces of various sizes.

Yet another object of this invention is to provide pliers with parallel jaws, as aforesaid, that operate in a manner similar to traditional locking pliers.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of pliers with generally parallel jaws according to a preferred embodiment of the present invention;

FIG. 2 is an exploded view of the pliers as in FIG. 1;

FIG. 3a is a side view of the pliers as in FIG. 1 in a closed configuration;

FIG. 3b is a side view of the pliers as in FIG. 1 in an open configuration;

FIG. 4a is a top view of the pliers as in FIG. 3a;

FIG. 4b is a sectional view taken along line 4b-4b of FIG. 4a;

FIG. 5a is a top view of the pliers as in FIG. 3b; and

FIG. 5b is a sectional view taken along line 5b-5b of FIG. 5a.

### DESCRIPTION OF THE PREFERRED EMBODIMENT

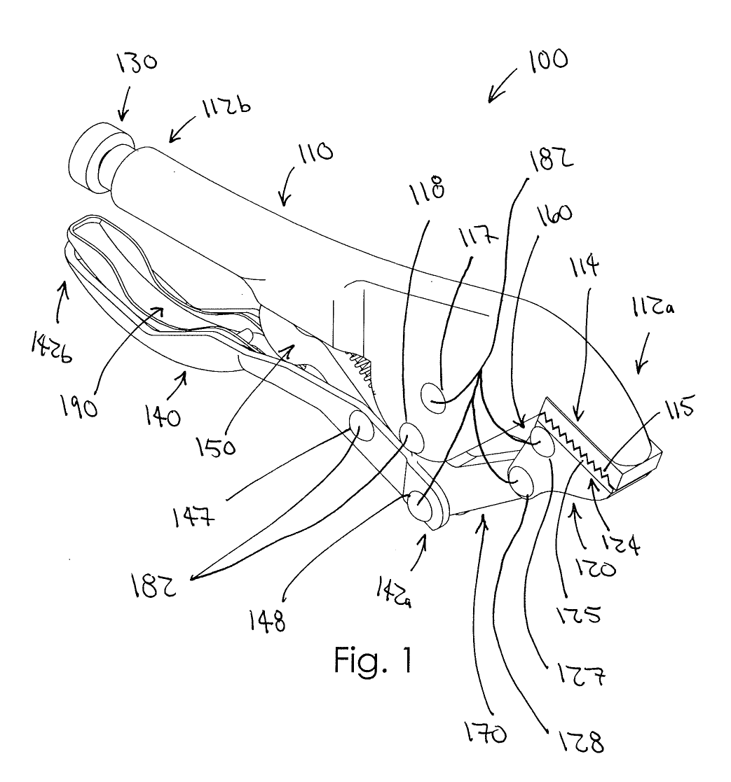

Pliers having generally parallel jaws according to the present invention will now be described in detail with reference to FIGS. 1 through 5b of the accompanying drawings. More particularly, pliers 100 according to one embodiment include a unitary upper portion 110, a lower jaw portion 120, an adjustment portion 130, a lower handle portion 140, a break-over link 150, a two-point link 160, and a three-point link 170.

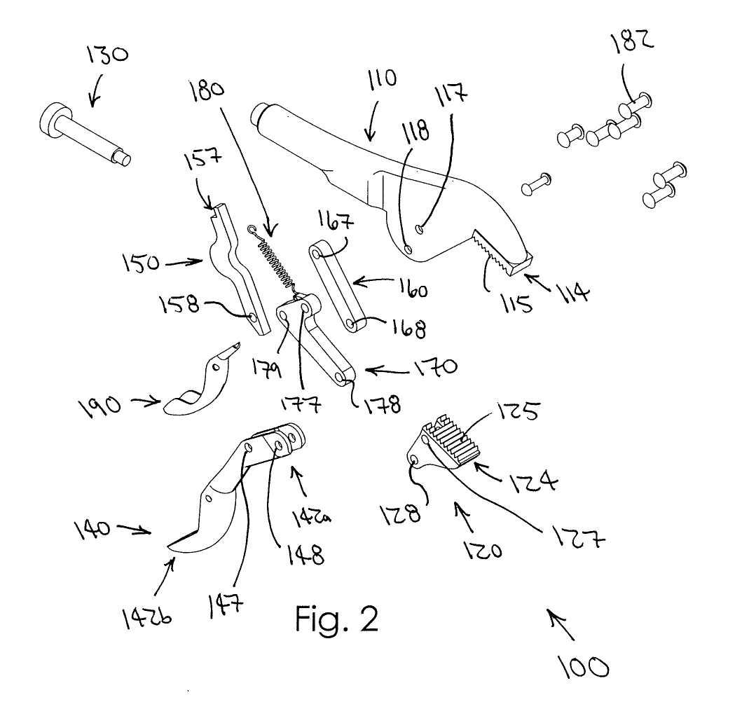

As shown in FIGS. 1 and 2, the upper portion 110 has front and rear ends 112a, 112b, and the front end 112a has an area (or “upper jaw”) 114 of generally planar upper teeth 115. It should be clear to those skilled in the art that the area or upper jaw 114 is generally planar, and that the teeth 115 may be individually pointed (as shown in the accompanying drawings), plateaued, rounded, et cetera. In other words, the teeth 115 are arranged generally linearly. The upper portion 110 has first and second pivot points 117, 118, as shown in FIGS. 1 and 2, for example.

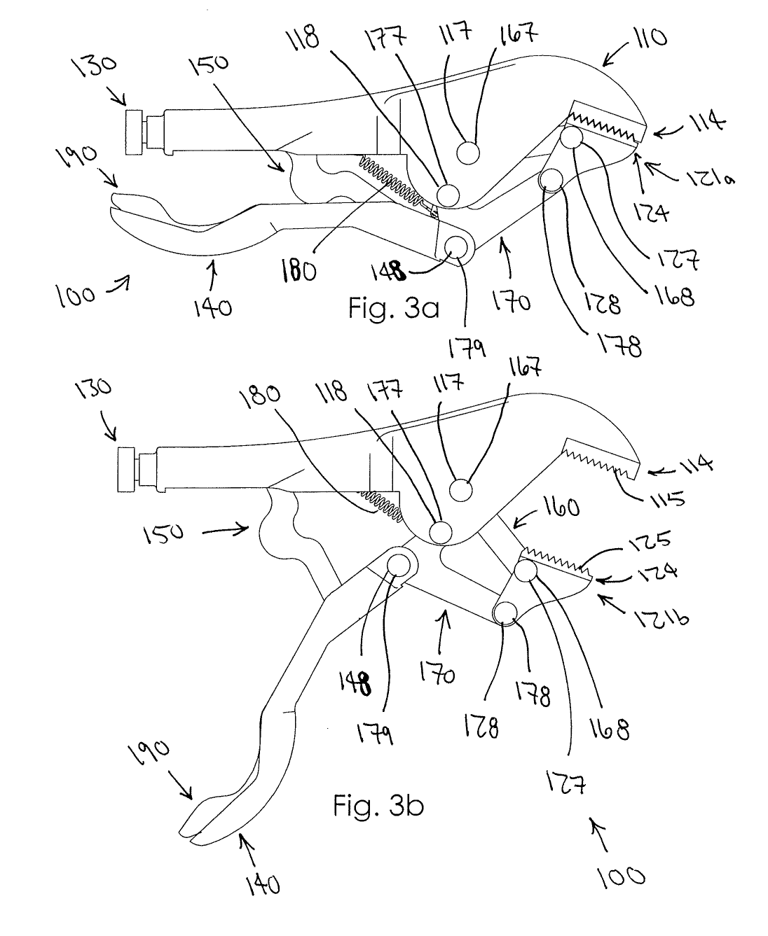

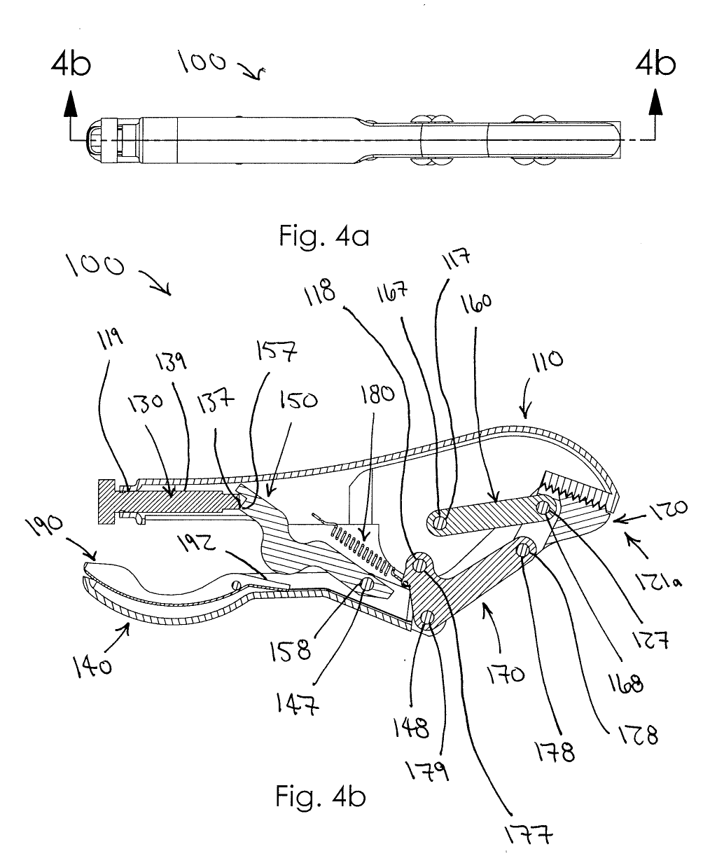

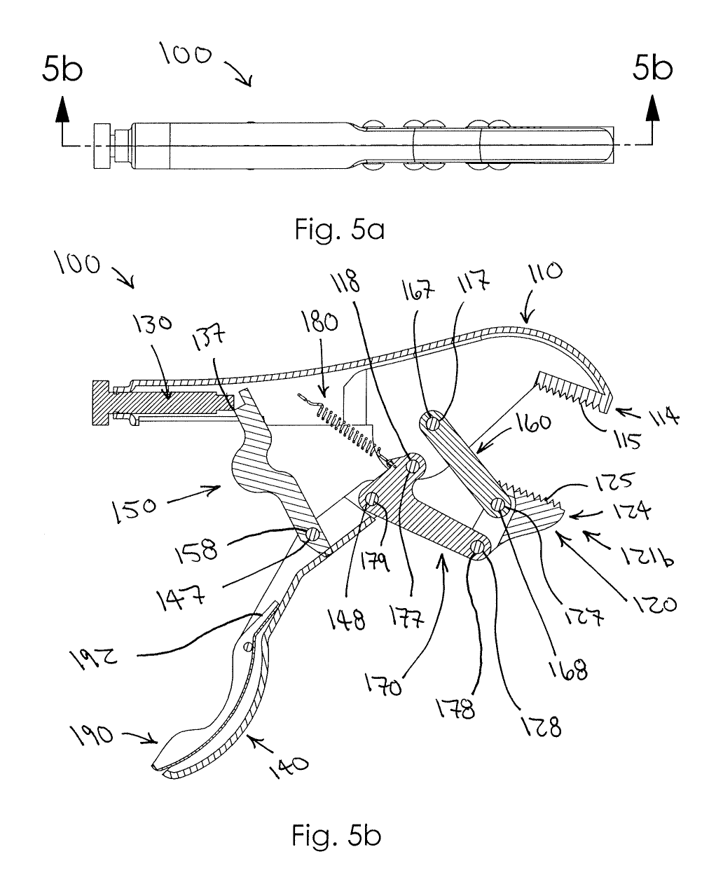

The lower jaw portion 120 (FIGS. 1 and 2) has an area (or “lower jaw”) 124 of generally planar lower teeth 125. Similar to the upper jaw and teeth 114, 115, the lower jaw 124 is generally planar, and the teeth 125 may be individually pointed (as shown in the accompanying drawings), plateaued, rounded, et cetera. In other words, the teeth 125 are arranged generally linearly. The lower jaw portion 120 has first and second pivot points 127, 128, as shown in FIGS. 1 and 2, for example. As discussed in further detail below, the lower jaw and teeth 124, 125 are movable from a first position 121a relatively near to the upper jaw and teeth 114, 115 (FIGS. 3a and 4b) to a second position 121b relatively distant to the upper jaw and teeth 114, 115 (FIGS. 3b and 5b). Importantly, the lower teeth 125 are always within ten degrees of parallel to the upper teeth 115, are preferably within five degrees of parallel to the upper teeth 115, and are more preferably within two degrees of parallel to the upper teeth 115. The amount of variance from parallel may depend on manufacturing tolerances and other factors.

The adjustment portion 130 (FIGS. 2, 4b, and 5b) is non-pivotably coupled to the upper portion 110 and is selectively movable relative to the upper portion 110. Various non-pivoting methods of attachment may be used; for example, the upper portion 110 may have a threaded section 119, and the adjustment portion 130 may have a threaded section 139 in communication with the threaded section 119 for adjustably coupling the adjustment portion 130 to the upper portion 110. Such an adjustment portion 130 and method of attachment are well known in the prior art, as one skilled in the art will appreciate. As shown in FIGS. 4b and 5b, the adjustment portion 130 includes a pivot point 137. In some embodiments, the pivot point 137 may move along the adjustment portion 130 based on the location of the adjustment portion 130 relative to the upper portion 110.

As shown in FIGS. 1 and 2, the lower handle portion 140 has front and rear ends 142a, 142b and first and second pivot points 147, 148.

The break-over link 150 (FIGS. 2, 4b, and 5b) has a first pivot point 157 pivotably coupled to the adjustment portion's pivot point 137 and a second pivot point 158 pivotably coupled to the lower handle portion's first pivot point 147. In some embodiments, the first pivot point 157 may move along the break-over link 150 based on the location of the adjustment portion 130 relative to the upper portion 110. Pivotal attachment of the pivot points 137, 157 is analogous to attachment of a break-over link to an adjustment portion in the prior art, and will be understood by those familiar with locking adjustable pliers. Unlike the prior art, however, force imparted by a spring 180 coupled to the upper portion 110 and the three-point link 170 may cause the break-over link's first pivot point 157 to be removably coupled to the adjustment portion's pivot point 137.

As shown in FIG. 4b, the break-over link's first and second pivot points 157, 158 and the lower handle portion's second pivot point 148 may all lie along a single (straight) imaginary line (not shown) when the lower teeth 125 are at the first position 121a, but not when the lower teeth 125 are at the second position 121b (FIG. 5b). And, as shown in FIG. 4b, the spring 180 may be generally parallel to the imaginary line passing through the break-over link's first and second pivot points 157, 158 and the lower handle portion's second pivot point 148 when the lower teeth 125 are at the first position 121a.

The two-point link 160 has a first pivot point 167 pivotably coupled to the upper portion's first pivot point 117 and a second pivot point 168 pivotably coupled to the lower jaw portion's first pivot point 127, as shown in FIGS. 2, 4b, and 5b.

The three-point link 170 is shown in FIGS. 2, 4b, and 5b and has first, second, and third pivot points 177, 178, 179 that are aligned non-linearly. In other words, the three-point link's first, second, and third pivot points 177, 178, 179 never lie along a single imaginary (straight) line concurrently. The first pivot point 177 is pivotably coupled to the upper portion's second pivot point 118, the second pivot point 178 is pivotably coupled to the lower jaw portion's second pivot point 128, and the third pivot point 179 is pivotably coupled to the lower handle portion's second pivot point 148. Turning now to FIGS. 3a, 3b, 4b, and 5b, an imaginary (straight) line (not shown) passing through the two-point link's first and second pivot points 167, 168 may always be generally parallel to an imaginary (straight) line (not shown) passing through the three-point link's first and second pivot points 177, 178.

Apart from the connection between the break-over link's first pivot point 157 and the adjustment portion's pivot point 137 (discussed above), pivotal coupling of pivot points set forth herein may be accomplished using pins 182 and/or other devices that allow rotation. It may be preferable for the pins 182 to be rivets, though other pins 182 may alternately be used.

As shown in FIGS. 4b and 5b, a break-over release 190 having an impact face 192 may be included. The break-over release 190 may be movably (e.g., rotatably) coupled to the lower handle portion 140 for the impact face 192 to selectively move the break-over link 150 relative to the lower handle portion 140.

In use, the adjustment portion 130 may be moved relative to the upper portion 110 (e.g., by screwing or unscrewing the adjustment portion 130 relative to the upper portion 110) to establish a desired amount of spacing between upper and lower jaws 114, 124, similar to the way that spacing is adjusted in traditional locking pliers. However, unlike traditional locking pliers, where an angle between the upper and lower jaws is changed when the spacing is changed, the upper and lower jaws 114, 124 maintain a generally parallel alignment because of the two-point link 160 and the three-point link 170 and the way that the various pivot points are aligned, as set forth above.

The lower handle portion 140 may be moved away from the upper portion 110 to cause the upper and lower jaws and teeth 114, 124, 115, 125 to become further separated from one another (i.e., to move to the second position 121b), as shown in FIGS. 3b and 5b, and may be moved toward the upper portion 110 to cause the upper and lower jaws and teeth 114, 124, 115, 125 to be relatively near one another (i.e., to move to the first position 121a), as shown in FIGS. 1, 3a, and 4b. While FIGS. 1, 3a, and 4b show the teeth 115, 125 to be touching when at the first position 121a, it should be appreciated that the distance between the teeth 115, 125 may be set using the adjustment portion 130, as set forth above. As with adjusting the distance between the teeth 115, 125 using the adjustment portion 130, movement of the teeth 115, 125 caused by moving the lower handle portion 140 relative to the upper portion 110 also maintains the generally parallel alignment between the upper and lower jaws 114, 124. This can be seen, for example, by comparing FIG. 3a to FIG. 3b, and is also due to the two-point link 160 and the three-point link 170 and the way that the various pivot points are aligned, as set forth above. Maintaining the upper and lower jaws and teeth 114, 124, 115, 125 generally parallel to one another is a significant advance over the prior art and greatly increases the functionality of the locking pliers 100 over those in the prior art.

Because of the positioning of the various pivot points and the inclusion of the spring 180, the jaws 114, 124 may be biased from leaving the first position 121a when at the first position 121a, and may be biased from leaving the second position 121b when at the second position 121b. To help overcome this bias and move the lower handle portion 140 away from the upper portion 110, force may be placed on the break-over release 190, causing the impact face 192 to move the lower handle portion 140 relative to the break-over link 150 (and the upper portion 110).

It is understood that while certain forms of this invention have been illustrated and described, it is not limited thereto except insofar as such limitations are included in the following claims and allowable functional equivalents thereof.

1. Pliers having generally parallel jaws, comprising:
a unitary upper portion having front and rear ends, said upper portion front end having an upper jaw of generally planar upper teeth, said upper portion having first and second pivot points;
a lower jaw portion having a lower jaw of generally planar lower teeth, said lower jaw portion having first and second pivot points, said generally planar lower teeth always being within ten degrees of parallel to said generally planar upper teeth;
an adjustment portion non-pivotably coupled to said upper portion, said adjustment portion being selectively movable relative to said upper portion, said adjustment portion having a first pivot point;
a lower handle portion having front and rear ends, said lower handle portion having first and second pivot points;
a break-over link having:
(a) a first pivot point pivotably coupled to said adjustment portion's first pivot point for adjusting a distance between said generally planar lower teeth and said generally planar upper teeth by moving said adjustment portion relative to said upper portion; and
(b) a second pivot point pivotably coupled to said lower handle portion's first pivot point;
a two-point link having:
(a) a first pivot point pivotably coupled to said upper portion's first pivot point; and
(b) a second pivot point pivotably coupled to said lower jaw portion's first pivot point; and
a three-point link having:
(a) a first pivot point pivotably coupled to said upper portion's second pivot point;
(b) a second pivot point pivotably coupled to said lower jaw portion's second pivot point; and
(c) a third pivot point pivotably coupled to said lower handle portion's second pivot point for moving said generally planar lower teeth between a first position relatively near to said generally planar upper teeth when said lower handle portion rear end is relatively near to said upper portion rear end and a second position relatively distant to said generally planar upper teeth when said lower handle portion rear end is relatively distant to said upper portion rear end;
wherein said first, second, and third pivot points of said three-point link never all lie along a single imaginary line concurrently.

2. The pliers of claim 1, further comprising a spring coupled to said three-point link and said upper portion.

3. The pliers of claim 2, further comprising a break-over release having an impact face, said break-over release being movably coupled to said lower handle portion for said impact face to selectively move said break-over link relative to said lower handle portion.

4. The pliers of claim 3, wherein an imaginary line passing through said two-point link's first and second pivot points is always generally parallel to an imaginary line passing through said three-point link's first and second pivot points.

5. The pliers of claim 4, wherein said break-over link's first and second pivot points and said lower handle portion's second pivot point all lie along a single imaginary line when said generally planar lower teeth are at said first position.

6. The pliers of claim 5, wherein said spring is generally parallel to said imaginary line passing through said break-over link's first and second pivot points and said lower handle portion's second pivot point when said generally planar lower teeth are at said first position.

7. The pliers of claim 6, wherein:
said upper portion has a threaded section; and
said adjustment portion has a threaded section in communication with said upper portion threaded section for adjustably coupling said adjustment portion to said upper portion.

8. The pliers of claim 7, wherein force imparted by said spring causes said break-over link's first pivot point to be removably coupled to said adjustment portion's first pivot point.

9. The pliers of claim 8, wherein:
a pin couples said break-over link's second pivot point to said lower handle portion's first pivot point;
a pin couples said two-point link's first pivot point to said upper portion's first pivot point;
a pin couples said two-point link's second pivot point to said lower jaw portion's first pivot point;
a pin couples said three-point link's first pivot point to said upper portion's second pivot point;
a pin couples said three-point link's second pivot point to said lower jaw portion's second pivot point; and
a pin couples said three-point link's third pivot point to said lower handle portion's second pivot point.

10. The pliers of claim 8, wherein:
a rivet couples said break-over link's second pivot point to said lower handle portion's first pivot point;
a rivet couples said two-point link's first pivot point to said upper portion's first pivot point;
a rivet couples said two-point link's second pivot point to said lower jaw portion's first pivot point;
a rivet couples said three-point link's first pivot point to said upper portion's second pivot point;
a rivet couples said three-point link's second pivot point to said lower jaw portion's second pivot point; and
a rivet couples said three-point link's third pivot point to said lower handle portion's second pivot point.

11. The pliers of claim 1, wherein an imaginary line passing through said two-point link's first and second pivot points is always generally parallel to an imaginary line passing through said three-point link's first and second pivot points.

12. Pliers, comprising:
a unitary upper portion having front and rear ends, said upper portion front end having a generally planar area of upper teeth, said upper portion having first and second pivot points;
an adjustment portion non-pivotably coupled to said upper portion, said adjustment portion being selectively movable relative to said upper portion, said adjustment portion having a first pivot point;
a lower handle portion having front and rear ends, said lower handle portion having first and second pivot points;
a lower jaw portion having a generally planar area of lower teeth, said lower jaw portion having first and second pivot points, said generally planar area of lower teeth being movable from a first position relatively near to said generally planar area of upper teeth to a second position relatively distant to said generally planar area of upper teeth, said generally planar area of lower teeth always being generally parallel to said generally planar area of upper teeth;
a break-over link having:
(a) a first pivot point pivotably coupled to said adjustment portion's first pivot point; and
(b) a second pivot point pivotably coupled to said lower handle portion's first pivot point;
a two-point link having:
(a) a first pivot point pivotably coupled to said upper portion's first pivot point; and
(b) a second pivot point pivotably coupled to said lower jaw portion's first pivot point; and
a three-point link having:
(a) a first pivot point pivotably coupled to said upper portion's second pivot point;
(b) a second pivot point pivotably coupled to said lower jaw portion's second pivot point; and
(c) a third pivot point pivotably coupled to said lower handle portion's second pivot point;
wherein said first, second, and third pivot points of said three-point link are aligned non-linearly.

13. The pliers of claim 12, wherein an imaginary line passing through said two-point link's first and second pivot points is always generally parallel to an imaginary line passing through said three-point link's first and second pivot points.
